(19) United States
(12) Patent Application Publication
(10) Pub. No.: US 2018/0141563 A1
(43) Pub. Date: May 24, 2018

(54) CLASSIFYING OF WEATHER SITUATIONS USING CAMERAS ON AUTOMOBILES

(71) Applicant: Faraday&Future Inc., Gardena, CA (US)

(72) Inventor: Jan Becker, Palo Alto, CA (US)

(21) Appl. No.: 15/639,122

(22) Filed: Jun. 30, 2017

Related U.S. Application Data
(60) Provisional application No. 62/357,271, filed on Jun. 30, 2016.

(51) Int. Cl. B60W 50/00; B60W 30/16; B60W 50/14; B60R 1/00; G01C 21/36; G06T 11/60; G06T 7/11

(52) U.S. Cl. CPC B60W 50/0098; B60W 30/16; B60W 50/14; B60R 1/00; G01C 21/3655; G06T 11/60; G06T 2207/30192; B60W 2050/146; B60W 2710/305; B60R 2300/303; B60W 2420/42; B60W 2550/12; G06T 7/11

(57) ABSTRACT

The disclosure is directed to classifying weather conditions using cameras and/or other sensors on a vehicle. The system can detect one or more weather conditions, such as a sunny sky, a cloudy sky, rain, lighting, thunderstorms, hail, snow, windy conditions, and darkness. The vehicle can account for the one or more weather conditions by dynamically and/or automatically modifying the vehicle's route, vehicle's mode(s) of operation, or a combination thereof. In some embodiments, the vehicle can automatically seek or suggest an alternate route; move the sun visor, sunroof, or window blind(s); change the temperature of a portion of the interior compartment; suggest a place to stop; automatically change the headlight intensity; activate fog lights and/or turn off high beams, change the distance from other vehicles; activate the electronic stability program, windshield wipers, and/or defroster; change the dynamics of driving; and/or change one or more thresholds.

### CROSS-REFERENCE TO RELATED APPLICATIONS

This application claims the benefit of U.S. Provisional Application No. 62/357,271, filed Jun. 30, 2016, the entirety of which is hereby incorporated by reference.

### FIELD OF THE DISCLOSURE

This relates generally to classifying weather conditions, and more particularly, to classifying weather conditions using automotive cameras.

### BACKGROUND OF THE DISCLOSURE

Vehicles, especially automobiles, increasingly include various sensors for detecting and gathering information about the vehicles' surroundings. For example, vehicles can include temperature sensors and/or rain sensors. However, existing weather-related sensors have limited functionality for classifying weather conditions.

### SUMMARY OF THE DISCLOSURE

Examples of the disclosure are directed to classifying weather conditions using cameras and/or other sensors on a vehicle. The system can detect one or more weather conditions, such as a sunny sky, a cloudy sky, rain, lighting, thunderstorms, hail, snow, windy conditions, and darkness. The vehicle can account for the one or more weather conditions by dynamically and/or automatically modifying the vehicle's route, vehicle's mode(s) of operation, or a combination thereof.

### BRIEF DESCRIPTION OF THE DRAWINGS

FIG. 1 illustrates an exemplary system block diagram of a vehicle control system according to examples of the disclosure.

FIG. 2 illustrates an exemplary method of operating the vehicle for weather classification and modification of the vehicle's route and/or vehicle's modes of operation according to examples of the disclosure.

FIG. 3A illustrates an exemplary driving condition with a glaring sun according to examples of the disclosure.

FIG. 3B illustrates an exemplary method of detecting a sun glaring through the windshield of a vehicle and adjusting the vehicle's operation according to examples of the disclosure.

FIG. 3C illustrates an exemplary method of detecting a sun glaring through the other windows of a vehicle and adjusting the vehicle's operation according to examples of the disclosure.

FIG. 4A illustrates an exemplary driving condition with a cloudy sky according to examples of the disclosure.

FIG. 4B illustrates an exemplary method of detecting a cloudy sky and adjusting the vehicle's operation according to examples of the disclosure.

FIG. 4C illustrates an exemplary method of detecting fog and adjusting the vehicle's operation according to examples of the disclosure.

FIG. 4D illustrates an exemplary method of detecting rain and adjusting the vehicle's operation according to examples of the disclosure.

FIG. 5 illustrates an exemplary method of detecting snow and/or ice and adjusting the vehicle's operation according to examples of the disclosure.

FIG. 6 illustrates an exemplary method of detecting a dark sky and adjusting the vehicle's operation according to examples of the disclosure.

FIG. 7 illustrates an exemplary stitched image of the surrounding weather according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Vehicles, especially automobiles, increasingly include various sensors for detecting and gathering information about the vehicles' surroundings. For example, vehicles can include temperature sensors and/or rain sensors. However, existing weather-related sensors can have limited functionality for classifying weather conditions.

Examples of the disclosure are directed to classifying weather conditions using cameras and/or other sensors on an automobile. The vehicle can detect one or more weather conditions, such as a sunny sky, a cloudy sky, rain, lighting, thunderstorms, hail, snow, windy conditions, and darkness. The vehicle can account for the one or more weather conditions by dynamically and/or automatically modifying the vehicle's route, vehicle's modes of operation, or a combination thereof.

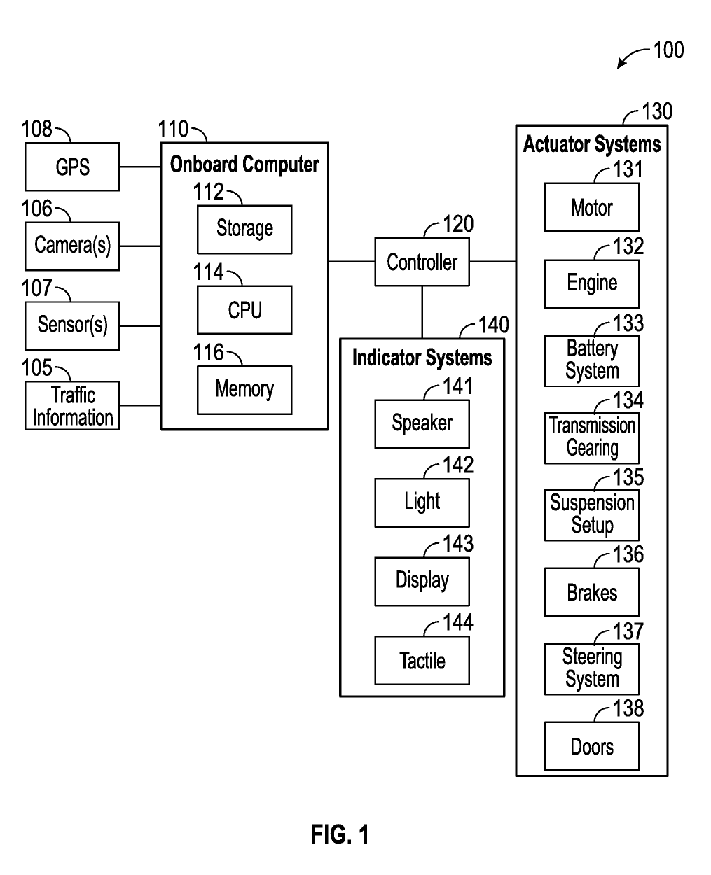

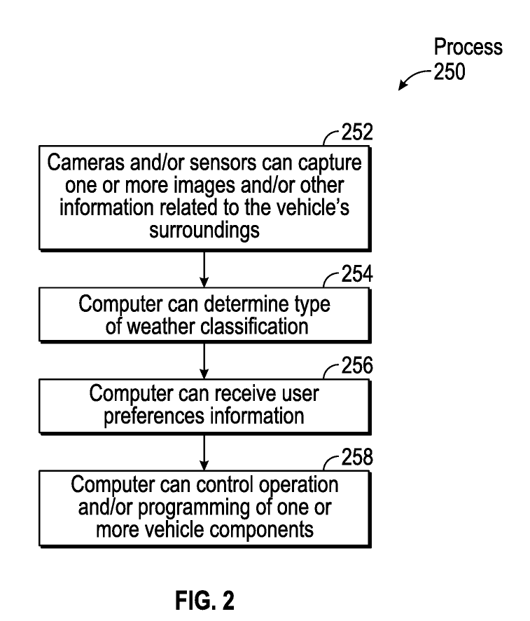

FIG. 1 illustrates an exemplary system block diagram of a vehicle control system according to examples of the disclosure. Vehicle control system 100 can perform any of the methods described with reference to FIGS. 2-7. System 100 can be incorporated into a vehicle, such as a consumer automobile. Other example vehicles that may incorporate the system 100 include, without limitation, airplanes, boats, motorcycles, or industrial automobiles.

Vehicle control system 100 can include one or more cameras 106 capable of capturing image data (e.g., video data) for determining various characteristics of the vehicle's surroundings. Cameras 106 can include, but is not limited to, forward looking camera(s) located on the front of the vehicle, surround view camera(s) located along the proximity of the vehicle, and rear view camera(s) located on the rear of the vehicle.

Vehicle control system 100 can also include one or more other sensors 107 (e.g., radar, ultrasonic, LIDAR, microphone etc.) capable of detecting various characteristics of the vehicle's surroundings. For example, sensors 107 can be used for detecting the presence of and distance from an object. Global Positioning System (GPS) receiver 108 can be capable of determining the location and/or position of the vehicle.

Vehicle control system 100 can include an on-board computer 110 that is coupled to the cameras 106, sensors 107, and GPS receiver 108, and that is capable of receiving the image data from the cameras 106 and/or outputs from the sensors 107 and the GPS receiver 108. The on-board computer 110 can be capable of controlling operation and/or programming the one or more components (e.g., interior shades, sunroof, temperature system, navigation system, control system, headlights, etc.) of the vehicle as described in this disclosure. On-board computer 110 can include storage 112, memory 116, and a processor (CPU) 114. CPU 114 can perform any of the methods described in this disclosure, including those described with reference to FIGS. 2-7. Additionally, storage 112 and/or memory 116 can store data and instructions (such as settings for operating or programming the vehicle components) for performing any of the methods described in this disclosure, including those described with reference to FIGS. 2-7. Storage 112 and/or memory 116 can be any non-transitory computer readable storage medium, such as a solid-state drive or a hard disk drive, among other possibilities. The vehicle control system 100 can also include a controller 120 capable of controlling one or more aspects of vehicle operation.

In some embodiments, the vehicle control system 100 can be connected to (e.g., via controller 120) one or more actuator systems 130 in the vehicle and one or more indicator systems 140 in the vehicle. The one or more actuator systems 130 can include, but are not limited to, a motor 131 or engine 132, battery system 133, transmission gearing 134, suspension setup 135, brakes 136, steering system 137, and door system 138. The vehicle control system 100 can control, via controller 120, one or more of these actuator systems 130 during vehicle operation; for example, to open or close one or more of the doors of the vehicle using the door actuator system 138, to control the vehicle during autonomous driving or parking operations using the motor 131 or engine 132, battery system 133, transmission gearing 134, suspension setup 135, brakes 136 and/or steering system 137, etc. The one or more indicator systems 140 can include, but are not limited to, one or more speakers 141 in the vehicle (e.g., as part of an entertainment system in the vehicle), one or more lights 142 in the vehicle, one or more displays 143 in the vehicle (e.g., as part of a control or entertainment system in the vehicle, such as a touch screen), and one or more tactile actuators 144 in the vehicle (e.g., as part of a steering wheel or seat in the vehicle). The vehicle control system 100 can control, via controller 120, one or more of these indicator systems 140 to provide indications to a user of the vehicle of the operation or programming of the one or more components (e.g., interior shades, sunroof, temperature system, navigation system, control system, headlights, etc.) controlled by the on-board computer 110 (e.g., to alert the user that programming of the components is complete). For example, one or more cameras 106 can capture image data of one or more weather conditions. The on-board computer 110 can classify weather based on the captured image. The indicator systems 140 can alert the driver and/or one or more passengers of the weather classification and/or can control the one or more components.

FIG. 2 illustrates an exemplary method of operating the vehicle for weather classification and modification of the vehicle's route and/or vehicle's modes of operation according to examples of the disclosure. The cameras (e.g., cameras 106 illustrated in FIG. 1) and/or sensors (e.g., sensors 107 illustrated in FIG. 1) can capture one or more images and/or other information related to the vehicle's surroundings (step 252 of process 250). Based on the captured one or more images and other surroundings information, the computer (e.g., on-board computer 110) can determine the type of weather classification (step 254 of process 250). For example, the weather can be classified as a sunny sky, a cloudy sky, rain, lighting, thunderstorms, hail, snow, windy conditions, and darkness. In some embodiments, the cameras and/or sensors can form a 2D or 3D “image” representing the weather conditions surrounding the vehicle. In some embodiments, the computer can receive (e.g., from user input or from memory) user (e.g., the driver and/or one or more passengers) preferences information (step 256 of process 250). Using the determined weather classification and/or user preferences, the computer can control operation and/or programming of one or more vehicle components (e.g., interior shades, sunroof, temperature system, navigation system, control system, headlights, etc.) (step 258 of process 250).

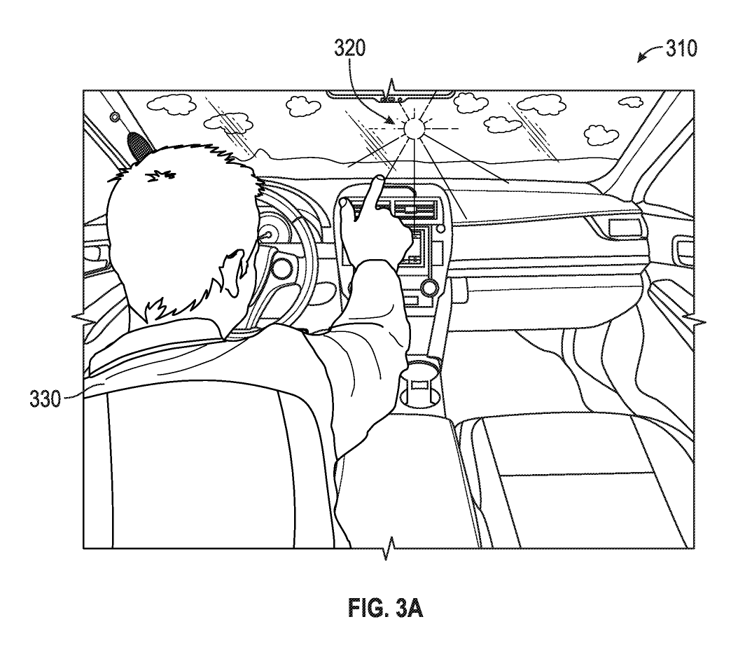

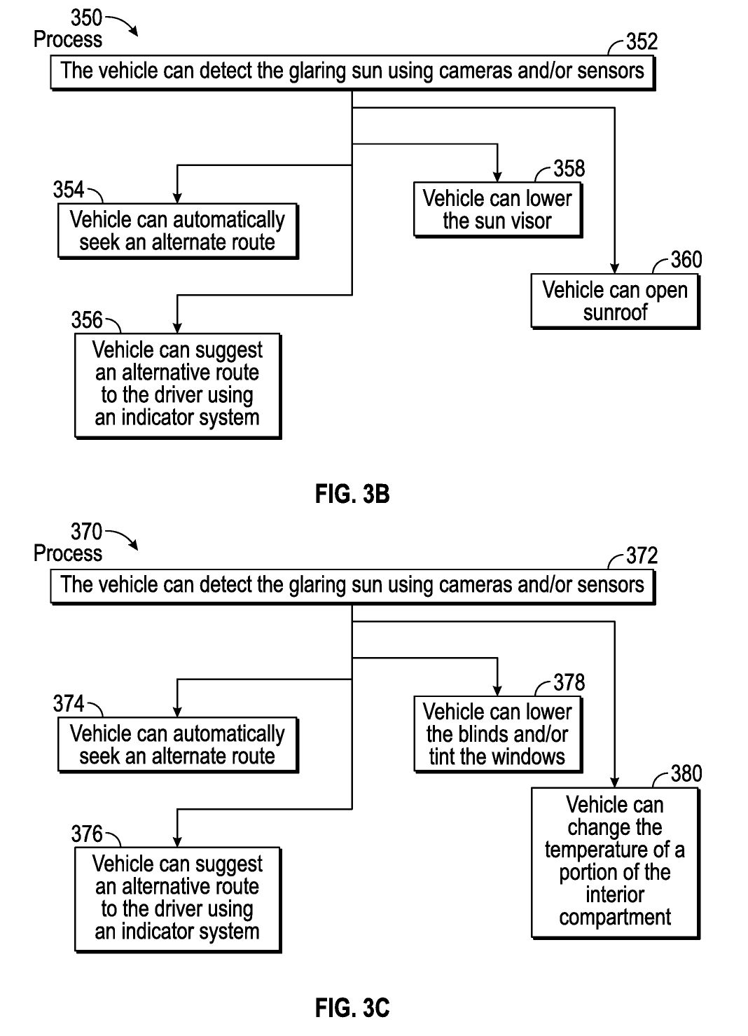

In some embodiments, the vehicle can detect a sunny sky. The sunny sky can include a glaring sun, a sky without clouds, a sky with a few clouds, and bright reflections off the vehicle's windows. The vehicle can determine the type of sunny sky, and based on the determined type, can adjust the vehicle's route and/or operation. For example, FIG. 3A illustrates an exemplary driving condition with a glaring sun, and FIG. 3B illustrates an exemplary method of detecting the driving condition and adjusting the vehicle's operation according to examples of the disclosure. A vehicle including an interior compartment 310 and can be driving on a sunny day. Sun 320 can shine directly into the eyes of driver 330, which may cause glare and obstruction of the view of driver 330. The vehicle can detect the glaring sun using one or more cameras and/or sensors (e.g., cameras 106 and/or sensors 107 illustrated in FIG. 1) (step 352 of process 350). The one or more cameras can include forward looking cameras. In some embodiments, to make driving conditions less hazardous, the vehicle can automatically seek an alternate route—one without or with less of the sun shining directly into the driver's eyes (step 354 of process 350). In some embodiments, the vehicle can suggest an alternate route to the driver using an indicator system (e.g., indicator system 140 illustrated in FIG. 1) (step 356 of process 350). In some embodiments, the vehicle can move (e.g., lower) the sun visor (step 358 of process 350). In some examples, the vehicle can open the sunroof (step 360 of process 350).

In some embodiments, the cameras and/or sensors can detect a sun glaring through the other windows of the vehicle. FIG. 3C illustrates an exemplary method of detecting a sun glaring through the other windows of a vehicle and adjusting the vehicle's operation according to examples of the disclosure. The vehicle can detect the glaring sun using one or more cameras and/or sensors (e.g., cameras 106 and/or sensors 107 illustrated in FIG. 1) (step 372 of process 370). The cameras can include surround view cameras. The sun glaring through the other windows of the vehicle can make conditions unpleasant for, e.g., one or more passengers. In some embodiments, to make conditions more pleasant for the one or more passengers, the vehicle can automatically seek an alternate route—one without or with less of the sun shining into the other windows of the vehicle (step 374 of process 370). In some embodiments, the vehicle can suggest an alternate route to the driver using an indicator system (e.g., indicator system 140 illustrated in FIG. 1) (step 376 of process 370). In some embodiments, the vehicle can move (e.g., lower) window blind(s) and/or tint the windows (e.g., using electrochromic windows) (step 378 of process 370). In some embodiments, the vehicle can change (e.g., increase) the temperature of one or more portions (e.g., rear portion) of the interior compartment to compensate for temperature differences due to the sun shining in a portion of the interior compartment (step 380 of process 370).

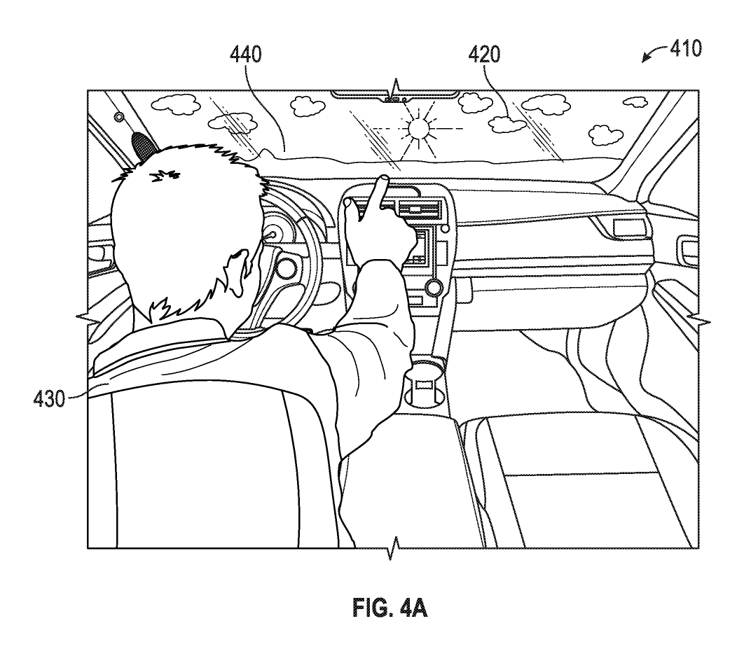

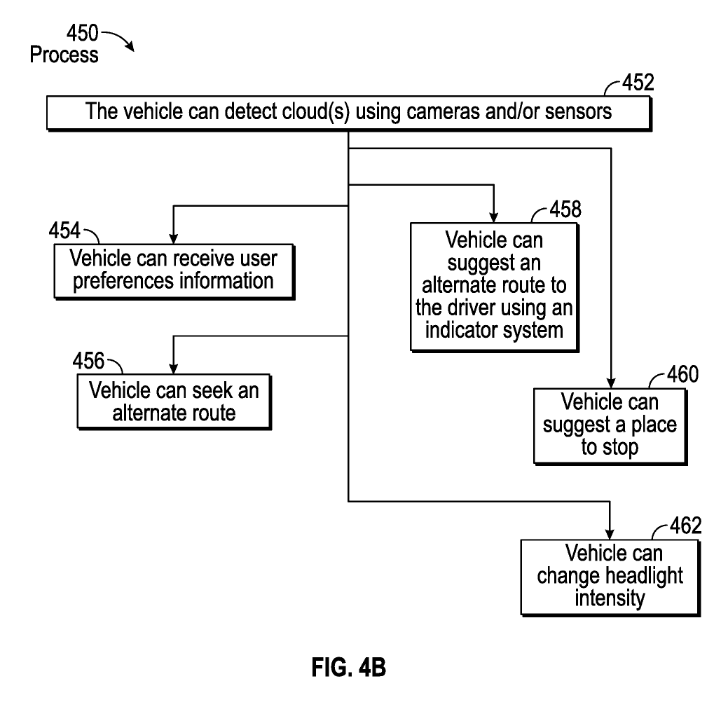

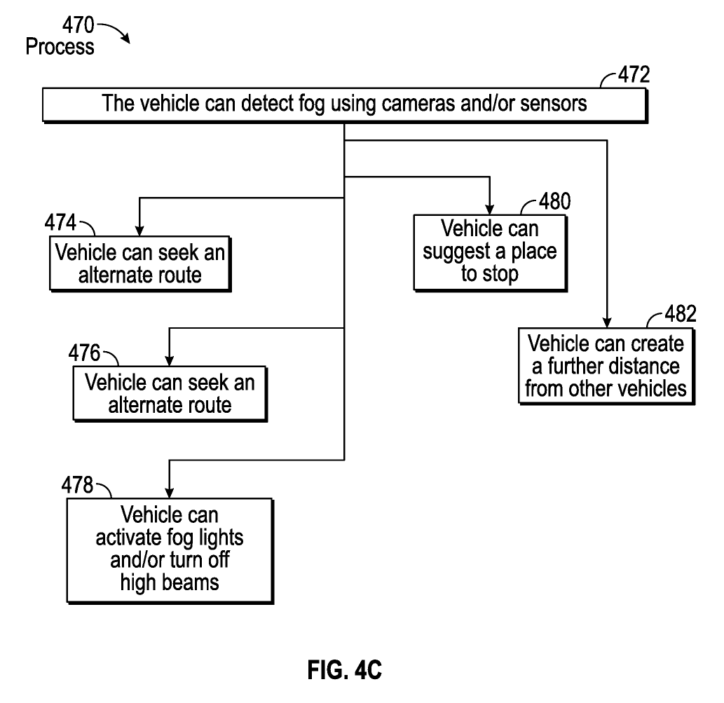

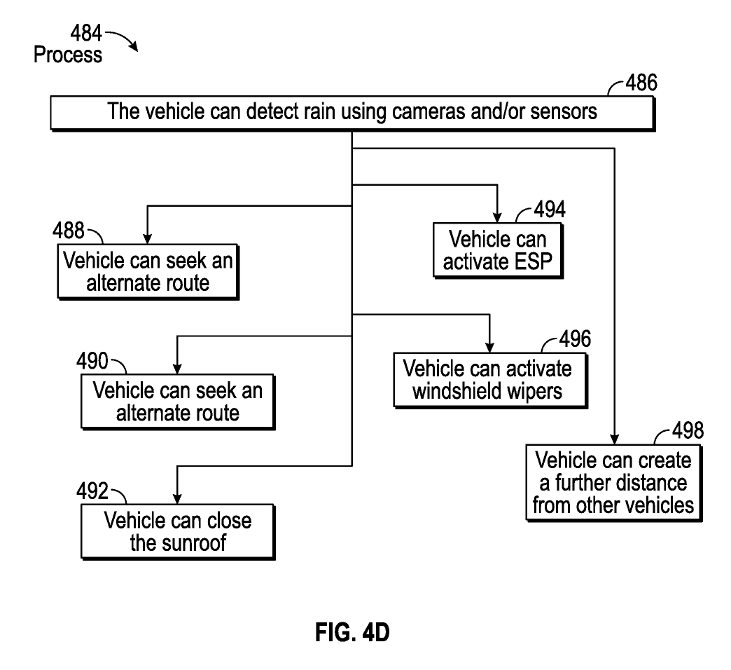

In some embodiments, the vehicle can detect a cloudy sky. The cloudy sky can include gray clouds, white clouds, and/or different types (e.g., cirrocumulus, cirrus, cumulonimbus, altocumulus, altostratus, stratocumulus, stratus, and cumulus) of clouds. The vehicle can determine the type of cloudy sky, and based on the determined type, can adjust the vehicle's route and/or operation. For example, FIG. 4A illustrates an exemplary driving condition with a cloudy sky, and FIG. 4B illustrates an exemplary method of detecting the driving condition and adjusting the vehicle's operation according to examples of the disclosure. A vehicle can include an interior compartment 410, and user 430 can be driving on a cloudy day. Clouds 420 can be located in sky 440. The vehicle can detect the cloud(s) and its properties using one or more cameras and/or sensors (e.g., cameras 106 and/or sensors 107 illustrated in FIG. 1) (step 452 of process 450). The cameras can include forward-looking cameras, surround view cameras, rear view cameras, or a combination thereof. The vehicle's computer (e.g., on-board computer 110 illustrated in FIG. 1) can receive (e.g., from user input or from memory) user (e.g., the driver and/or one or more passengers) preferences information (step 454 of process 450). In some embodiments, the user may prefer to avoid driving in the rain, and the computer can determine that clouds 420 are gray clouds. In some embodiments, to avoid having the user drive in the rain, the vehicle can automatically seek an alternate route—one without or with fewer gray clouds (step 456 of process 450). In some embodiments, the vehicle can suggest an alternate route to the driver using an indicator system (e.g., indicator system 140 illustrated in FIG. 1) (step 458 of process 450). In some embodiments, the vehicle can determine how long the driver can travel before it rains (e.g., using additional information from weather predictions and/or audible detection of lighting/thunder using a microphone) and can suggest a place to stop (e.g., hotel, restaurant, shopping center) to avoid driving in the rain, hail, thunderstorms, and/or lightning (step 460 of process 450). In some embodiments, the vehicle can automatically change the headlight intensity (e.g., increase the brightness as the clouds create a darker sky) (step 462 of process 450).

In some embodiments, the cameras and/or sensors can detect fog. FIG. 4C illustrates an exemplary method of detecting fog and adjusting the vehicle's operation according to examples of the disclosure. The vehicle can detect the fog using one or more cameras and/or sensors (e.g., cameras 106 and/or sensors 107 illustrated in FIG. 1) (step 472 of process 470). The cameras can include surround view cameras. The fog can limit the driver's visibility and can make driving conditions hazardous. In some embodiments, to avoid hazardous driving conditions, the vehicle can automatically seek an alternate route—one without fog or with less fog (step 474 of process 470). In some embodiments, the vehicle can suggest an alternate route to the driver using an indicator system (e.g., indicator system 140 illustrated in FIG. 1) (step 476 of process 470). In some embodiments, the vehicle can activate fog lights and/or turn off high beams to enhance the driver's visibility (step 478 of process 470). In some embodiments, the vehicle can suggest a place to stop (e.g., hotel, restaurant, shopping center) to avoid driving in the fog (step 480 of process 470). In some embodiments, the vehicle can account for the poor visibility and can change (e.g., increase) the distance from other vehicles (step 482 of process 470).

In some embodiments, the vehicle can detect rain. FIG. 4D illustrates an exemplary method of detecting rain and adjusting the vehicle's operation according to examples of the disclosure. The vehicle can detect the rain using one or more cameras and/or sensors (e.g., cameras 106 and/or sensors 107 illustrated in FIG. 1) (step 486 of process 484). The cameras can include surround view cameras. The rain can limit the driver's visibility and can make driving conditions hazardous. In some embodiments, to avoid hazardous driving conditions, the vehicle can automatically seek an alternate route—one without rain or with less rain (step 488 of process 484). In some embodiments, the vehicle can suggest an alternate route to the driver using an indicator system (e.g., indicator system 140 illustrated in FIG. 1) (step 490 of process 484). In some examples, the vehicle can close the sunroof (step 492 of process 484). In some embodiments, the vehicle can activate the electronic stability program (ESP) (step 494 of process 484). In some embodiments, the vehicle can activate the windshield wipers (step 496 of process 484). In some embodiments, the vehicle can account for the poor visibility and/or change in weather conditions by changing (e.g., increasing) one or more parameters associated with the dynamics of driving (e.g., torque, driving gear, etc.). For example, the vehicle can create a further distance from other vehicles (step 498 of process 484). The vehicle can make the changes (e.g., switch to one or more different parameters) automatically (e.g., without the driver's input or control) when or shortly (e.g., 5 min) after the rain is detected. In some embodiments, the vehicle can change one or more thresholds (e.g., warnings or notifications to the user, range of acceptable conditions, etc.) based on the weather classification. For example, the vehicle can change (e.g., decrease) the acceptable threshold of tire pressure when rain is detected.

In some examples, the weather classification can be used for detecting shadows. For example, blue skies and/or direct sunlight are more likely to create shadows. Detection of shadows can be used for removing false positives (discussed below).

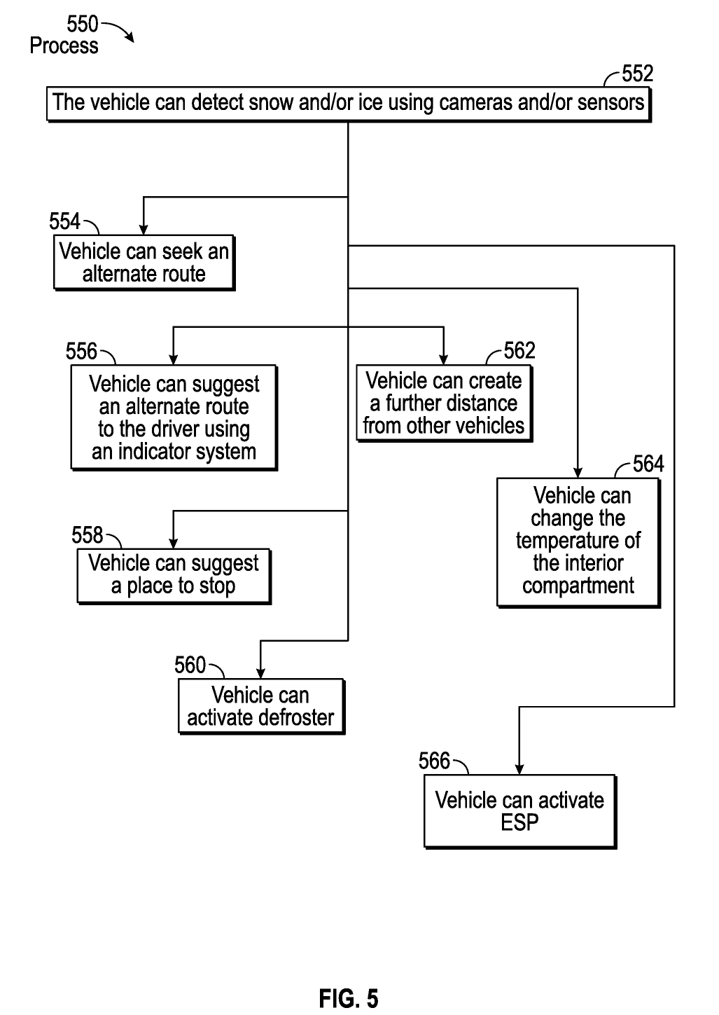

In some embodiments, the cameras and/or sensors can detect snow and/or ice. FIG. 5 illustrates an exemplary method of detecting snow and/or ice and adjusting the vehicle's operation according to examples of the disclosure. The vehicle can detect the snow and/or using one or more cameras and/or sensors (e.g., cameras 106 and/or sensors 107 illustrated in FIG. 1) (step 552 of process 550). The snow and/or ice can make driving conditions hazardous with slippery roads and poor visibility. In some embodiments, to avoid hazardous driving conditions, the vehicle can automatically seek an alternate route—one without or with less snow/ice (step 554 of process 550). In some embodiments, the vehicle can suggest an alternate route to the driver using an indicator system (e.g., indicator system 140 illustrated in FIG. 1) (step 556 of process 550). In some embodiments, the vehicle can suggest a place to stop (e.g., hotel, restaurant, shopping center) to avoid driving in the snow and/or ice (step 558 of process 550). In some embodiments, the vehicle can activate the defroster to enhance the driver's visibility (step 560 of process 550). In some embodiments, the vehicle can account for the poor visibility, slippery road conditions, and/or change in weather conditions by changing (e.g., increasing) one or more parameters associated with the dynamics of driving (e.g., torque, driving gear, etc.). For example, a further distance from other vehicles can be created (step 562 of process 550), or the vehicle can shift to a lower gear. The vehicle can make the changes (e.g., switch to one or more different parameters) automatically (e.g., without the driver's input or control) when or shortly (e.g., 5 min) after the snow/ice is detected. In some embodiments, the vehicle can change one or more thresholds (e.g., warnings or notifications to the user, range of acceptable conditions, etc.) based on the weather classification. For example, the vehicle can change (e.g., decrease) the acceptable threshold of tire pressure when snow/ice is detected. In some embodiments, the vehicle can change (e.g., increase) the temperature of the interior compartment to provide warmth from the cold temperatures associated with snow and/or ice (step 564 of process 550). In some embodiments, the vehicle can activate the electronic stability program (ESP) (step 566 of process 550).

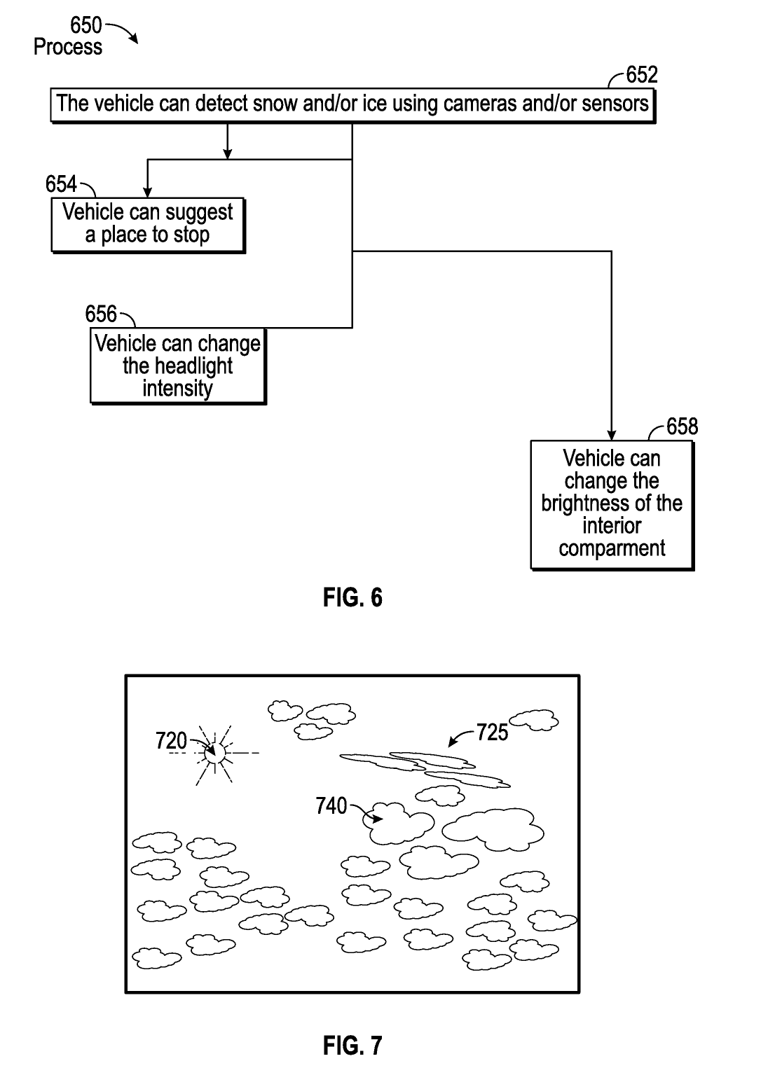

In some embodiments, the cameras and/or sensors can detect a dark sky. FIG. 6 illustrates an exemplary method of detecting a dark sky and adjusting the vehicle's operation according to examples of the disclosure. The vehicle can detect the dark sky using one or more cameras and/or sensors (e.g., cameras 106 and/or sensors 107 illustrated in FIG. 1) (step 652 of process 650). The dark sky can limit the driver's visibility and can create hazardous driving conditions. In some embodiments, the vehicle can suggest a place to stop (e.g., hotel, rest stop) to avoid driving in the dark (step 654 of process 650). In some embodiments, the vehicle can automatically change (e.g., increase the brightness) the headlight intensity (step 656 of process 650). In some embodiments, the vehicle can automatically change (e.g., increase) the brightness of the interior compartment lights (e.g., console lights) (step 658 of process 650).

The sensors can further be capable of determine an angle or orientation of the vehicle. The angle or orientation of the vehicle can be used to enhance the accuracy of classifying the weather. The angle or orientation of the vehicle can affect the field of view of the cameras and/or sensors included in the vehicle. The field of view of the cameras and/or sensors can be related to one or more properties of the weather. For example, if the vehicle is driving downhill, the cameras may be capturing low horizon images. The angle information can be used, for example, to determine that the clouds are low-level clouds, which may help the on-board computer discern between stratus and cirrostratus clouds.

In some embodiments, the cameras and/or sensors (e.g., cameras 106 and/or sensors 107 illustrated in FIG. 1) can be capable of determining whether the images of, e.g., clouds or lightning, are from a reflection off a window, building, or another reflective surface. In some embodiments, the cameras and/or sensors can be capable of determining whether the images are shadows. The vehicle's computer (e.g., on-board computer 110) can prevent false positives when receiving this information. In some embodiments, the vehicle's computer can ignore any false positives to prevent an inaccurate classification of weather and/or a false stitched image. For example, an image of a cloud may reflect off a window towards the forward-looking cameras included in the vehicle. The cloud may, however, be located behind the vehicle. Without determining that the image is from a reflection off the window, the vehicle's computer may mistakenly believe the cloud is located in front of the vehicle. In some embodiments, the computer can further utilize information from a GPS system (e.g., GPS receiver 108) and/or map service to detect the reflection. For example, if the GPS system and/or map service communicates the location of a building and the vehicle determines that the weather includes a sunny sky, the vehicle's computer can determine that images capture from that location can include reflections off the building. The vehicle's computer may then ignore the captured image to prevent any mistaken belief that the images originate directly from the sky.

In some embodiments, the vehicle's computer (e.g. on-board computer 110) can be configured to receive the images and/or other information from the cameras and/or sensors (e.g., cameras 106 and/or sensors 107 illustrated in FIG. 1) and can stitch together the images to form a composite image of the surrounding weather, as illustrated in FIG. 7. The stitched together image can show various weather-related objects such as sun 720, sky 725, and cloud 740.

The cameras can include forward looking cameras, surround view cameras, and rear view cameras. In some embodiments, the indicator system (e.g., indicator system 140 illustrated in FIG. 1) can display (e.g., using display 143 illustrated in FIG. 1) the stitched image and/or related weather information to the driver and/or one or more passengers. In some embodiments, the vehicle can send (e.g., using a transceiver) the stitched image and/or related weather information for providing a more frequent update to one or more weather stations, servers, databases, and/or crowdsourcing services (e.g., traffic update services).

A method of operating a vehicle is disclosed. The method can comprise: capturing one or more images of surroundings of the vehicle using one or more cameras attached to the vehicle; detecting one or more characteristics surrounding the vehicle using the one or more images; associating the one or more characteristics with one or more weather conditions; and controlling an operation of one or more vehicle components based on the one or more weather conditions. Additionally or alternatively, in some examples, controlling the operation includes automatically seeking an alternate route. Additionally or alternatively, in some examples, controlling the operation includes suggesting an alternate route to a driver using an indicator system. Additionally or alternatively, in some examples, the one or more cameras include a forward-looking camera, the one or more weather conditions include a sunny sky, and controlling the operation includes moving a sun visor. Additionally or alternatively, in some examples, the one or more cameras include a forward-looking camera, the one or more weather conditions include a sunny sky, and controlling the operation includes opening a sunroof. Additionally or alternatively, in some examples, the one or more cameras include a surround view camera, the one or more weather conditions include a sunny sky, and controlling the operation includes moving a window blind or tinting a window. Additionally or alternatively, in some examples, the one or more weather conditions include a sunny sky or snow, and further wherein controlling the operation includes changing a temperature of a portion of an interior compartment of the vehicle. Additionally or alternatively, in some examples, the one or more characteristics include one or more clouds, fog, or rain, and further wherein controlling the operation includes suggesting a stop location to a driver of the vehicle using an indicator system. Additionally or alternatively, in some examples, the one or more characteristics include one or more clouds or dark sky, and further wherein controlling the operation includes changing a headlight intensity. Additionally or alternatively, in some examples, the one or more characteristics include fog, and controlling the operation includes activating fog lights, turning off high beams, or both. Additionally or alternatively, in some examples, the one or more weather conditions include rain, fog, or snow, and further wherein controlling the operation includes increasing a distance from the vehicle to another vehicle. Additionally or alternatively, in some examples, the one or more weather conditions include rain, and controlling the operation includes closing a sunroof, activating windshield wipers, or both. Additionally or alternatively, in some examples, the one or more weather conditions include rain or snow, and further wherein controlling the operation includes activating an electronic stability program. Additionally or alternatively, in some examples, the one or more weather conditions include snow, and controlling the operation includes activating a defroster. Additionally or alternatively, in some examples, the one or more weather conditions include a dark sky, and controlling the operation includes changing a brightness of interior compartment lights. Additionally or alternatively, in some examples, detecting the one or more characteristics include capturing a plurality of images, the method further comprising: stitching together the plurality of images to form a composite image; and displaying the composite image on a display. Additionally or alternatively, in some examples, the method further comprises: communicating the one or more weather conditions to a weather station, server, database, or crowd sourcing service.

A vehicle is disclosed. The vehicle can comprise: one or more cameras configured to capture one or more images of surroundings of the vehicle, the one or more cameras attached to the vehicle; one or more sensors configured to detect a presence of and distance from an object; and an on-board computer configured to: determine the one or more characteristics surrounding the vehicle using the captured one or more images, associating the one or more characteristics to one or more weather conditions, and controlling an operation of one or more vehicle components based on the one or more weather conditions. Additionally or alternatively, in some examples, the vehicle further comprises: a display configured to display a composite image, wherein the composite image is formed by stitching together the captured one or more images. Additionally or alternatively, in some examples, the vehicle further comprises: a transceiver configured to communicate with a weather station, server, database, or crowd sourcing service, wherein communication includes transmitting the one or more weather conditions. Additionally or alternatively, in some examples, the one or more vehicle components include one or more of an indicator system, a sun visor, a sunroof, a window blind, a window, a temperature system, headlights, fog lights, windshield wipers, an electronic stability program, a defroster, and interior lights.

A non-transitory computer-readable medium is disclosed. The non-transitory computer-readable medium can include instructions, which when executed by one or more processors, causing the one or more processors to perform a method comprising: capturing one or more images of surroundings of the vehicle using one or more cameras attached to the vehicle; detecting one or more characteristics surrounding the vehicle using the one or more images; associating the one or more characteristics with one or more weather conditions; and controlling an operation of one or more vehicle components based on the one or more weather conditions.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

What is claimed:

1. A method of operating a vehicle, the method comprising:
capturing one or more images of surroundings of the vehicle using one or more cameras attached to the vehicle;
detecting one or more characteristics surrounding the vehicle using the one or more images;
associating the one or more characteristics with one or more weather conditions; and
controlling an operation of one or more vehicle components based on the one or more weather conditions.

2. The method of claim 1, wherein controlling the operation includes automatically seeking an alternate route.

3. The method of claim 1, wherein controlling the operation includes suggesting an alternate route to a driver using an indicator system.

4. The method of claim 1, wherein the one or more cameras include a forward-looking camera, the one or more weather conditions include a sunny sky, and controlling the operation includes moving a sun visor.

5. The method of claim 1, wherein the one or more cameras include a forward-looking camera, the one or more weather conditions include a sunny sky, and controlling the operation includes opening a sunroof.

6. The method of claim 1, wherein the one or more cameras include a surround view camera, the one or more weather conditions include a sunny sky, and controlling the operation includes moving a window blind or tinting a window.

7. The method of claim 1, wherein the one or more weather conditions include a sunny sky or snow, and further wherein controlling the operation includes changing a temperature of a portion of an interior compartment of the vehicle.

8. The method of claim 1, wherein the one or more characteristics include one or more clouds, fog, or rain, and further wherein controlling the operation includes suggesting a stop location to a driver of the vehicle using an indicator system.

9. The method of claim 1, wherein the one or more characteristics include one or more clouds or dark sky, and further wherein controlling the operation includes changing a headlight intensity.

10. The method of claim 1, wherein the one or more characteristics include fog, and controlling the operation includes activating fog lights, turning off high beams, or both.

11. The method of claim 1, wherein the one or more weather conditions include rain, fog, or snow, and further wherein controlling the operation includes increasing a distance from the vehicle to another vehicle.

12. The method of claim 1, wherein the one or more weather conditions include rain, and controlling the operation includes closing a sunroof, activating windshield wipers, or both.

13. The method of claim 1, wherein the one or more weather conditions include rain or snow, and further wherein controlling the operation includes activating an electronic stability program.

14. The method of claim 1, wherein the one or more weather conditions include snow, and controlling the operation includes activating a defroster.

15. The method of claim 1, wherein the one or more weather conditions include a dark sky, and controlling the operation includes changing a brightness of interior compartment lights.

16. The method of claim 1, wherein detecting the one or more characteristics include capturing a plurality of images, the method further comprising:
stitching together the plurality of images to form a composite image; and
displaying the composite image on a display.

17. The method of claim 1, further comprising:
communicating the one or more weather conditions to a weather station, server, database, or crowd sourcing service.

18. A vehicle comprising:
one or more cameras configured to capture one or more images of surroundings of the vehicle, the one or more cameras attached to the vehicle;
one or more sensors configured to detect a presence of and distance from an object; and
an on-board computer configured to:
determine the one or more characteristics surrounding the vehicle using the captured one or more images,
associating the one or more characteristics to one or more weather conditions, and
controlling an operation of one or more vehicle components based on the one or more weather conditions.

19. The vehicle of claim 18, further comprising:
a display configured to display a composite image, wherein the composite image is formed by stitching together the captured one or more images.

20. A non-transitory computer-readable medium including instructions, which when executed by one or more processors, cause the one or more processors to perform a method comprising:
capturing one or more images of surroundings of the vehicle using one or more cameras attached to the vehicle;
detecting one or more characteristics surrounding the vehicle using the one or more images;
associating the one or more characteristics with one or more weather conditions; and
controlling an operation of one or more vehicle components based on the one or more weather conditions.
